(19) United States
(12) Patent Application Publication
(10) Pub. No.: US 2012/0151013 A1
(43) Pub. Date: Jun. 14, 2012

(54) LEGACY USB DEVICE SERVICE SYSTEM IN MOBILE TERMINAL AND METHOD THEREOF

(75) Inventors: Dong-oh KANG, Daejeon (KR); Jeunwoo Lee, Daejeon (KR)

(73) Assignee: Electronics and Telecommunications Research Institute, Daejeon (KR)

(21) Appl. No.: 13/323,736

(22) Filed: Dec. 12, 2011

(30) Foreign Application Priority Data
Dec. 14, 2010 (KR) 10-2010-0127728

(51) Int. Cl. G06F 15/16

(52) U.S. Cl. 709/219

(57) ABSTRACT

Disclosed are a legacy universal serial bus (USB) device service system in a mobile terminal and a method thereof. The USB device service system includes: a remote USB bridge being connected by at least one legacy USB device; a terminal being connected to the remote USB bridge over a wireless network to provide information about the legacy USB device to a user, and to receive a user input for use of the legacy USB device; and a USB device driver server being connected to the remote USB bridge and the terminal over the wireless network to provide a driving driver for driving the legacy USB device according to the user input.

### CROSS-REFERENCE TO RELATED APPLICATIONS

This application claims priority to and the benefit of Korean Patent Application No. 10-2010-0127728 filed in the Korean Intellectual Property Office on Dec. 14, 2010, the entire contents of which are incorporated herein by reference.

### TECHNICAL FIELD

The present invention relates to a legacy universal serial bus (USB) device service system in a mobile terminal and a method thereof. More particularly, the present invention relates to a service system and method that enables a user to use a general legacy USB device using a wireless network in a mobile terminal such as a mobile phone or a personal digital assistant (PDA).

### BACKGROUND

In general, a universal serial bus (USB) functions as a USB device and a USB host. The USB device is a device to provide a function of the USB device to the USB host and functions as a server, and the USB host functions as a client for controlling the USB device and requesting a function. An existing mobile terminal has employed the USB device through a scheme of functioning as the USB device or embedding a USB port to thereby function as the USB host.

As described above, when using the USB device in a conventional mobile terminal, the USB port needs to be embedded in the mobile terminal and a device driver needs to be embedded with respect to each USB device or to be installed by a user. However, in the conventional method, since the mobile terminal needs to provide power of the USB device, it has decreased the power of a battery of the mobile terminal and caused an unstable operation of the USB device.

Also, since the user needs to install a USB device driving driver in order to drive a corresponding USB device every time, it causes user inconvenience.

Accordingly, based on the above issues, proposed herein are a legacy USB device service system that is connected to a remote USB bridge embedded with a USB port over a wireless network instead of an existing mobile terminal embedded with the USB port and thereby uses a legacy USB device connected to the remote USB bridge, and a method thereof.

### SUMMARY

The present invention has been made in an effort to provide a legacy universal serial bus (USB) device service system and method of employing a legacy USB device connected to a remote USB bridge using a wireless network of a mobile terminal having a wireless network function.

However, the technical object of the present invention is not limited to the aforementioned object and other objects not described above may be clearly understood by those skilled in the art from the following description.

An exemplary embodiment of the present invention provides a USB device service system, including: a remote USB bridge being connected by at least one legacy USB device, a terminal being connected to the remote USB bridge over a wireless network to provide information about the legacy USB device to a user, and to receive a user input for use of the legacy USB device, and a USB device driver server being connected to the remote USB bridge and the terminal over the wireless network to provide a driving driver for driving the legacy USB device according to the user input.

The terminal may include a user interface unit to receive the user input and to output an operation result of the legacy USB device, and a remote USB client control unit to collect information about the legacy USB device from the remote USB bridge, and to transfer the collected information to the user interface unit.

The terminal may further include a remote USB device unit controlling the legacy USB device, selected according to the user input inputted into the user interface unit, to be connected to the terminal, and a USB device driver server connecting unit controlling a driving driver for driving the legacy USB device connected to the terminal to be downloaded from the USB device driver server.

The user interface unit may provide, to the user, enquiry information about the peripheral remote USB bridge and the legacy USB device connected to the remote USB bridge.

The user interface unit may transmit a command for connecting the legacy USB device selected by the user to the terminal to the remote USB bridge.

The remote USB bridge may include a USB core functioning unit to recognize the legacy USB device as a plug-and-play format, a remote USB host unit to control the legacy USB device via the USB core functional unit, and to connect the legacy USB device and the terminal over the wireless network, and a remote USB control unit to transmit information about the legacy USB device recognized by the USB core functioning unit to the terminal, and to control the remote USB host unit according to the user input inputted into the terminal.

The USB device driver server may include a connection server unit to receive information about the terminal and information about the legacy USB device, and a USB device driver storing unit to provide the driving driver for driving the legacy USB device to the terminal based on information received by the connection server unit.

Information about the terminal may include at least one of a type of hardware of the terminal, a type of an operating system of the terminal, and a version thereof.

Another exemplary embodiment of the present invention provides a USB device service method, including: transmitting a request for using a legacy USB device to a remote USB bridge connected by a remote legacy USB device via a terminal of a user; connecting the legacy USB device to the terminal according to the request; and downloading a driving driver for driving the legacy USB device in the terminal to the terminal by verifying information about the terminal and information about the legacy USB device.

The transmitting may include requesting information enquiry about the legacy USB device connected to the remote USB bridge via the terminal of the user, transmitting information about the legacy USB device to the terminal according to the request, and transmitting a request for using a legacy USB device desired to be used to the remote USB bridge based on the transmitted information.

The transmitting, the connecting, and the downloading may be performed over the wireless network.

According to exemplary embodiments of the present invention, even a mobile terminal not embedded with a USB port may employ a legacy USB device using a wireless network and may not decrease battery power of the mobile terminal.

According to exemplary embodiments of the present invention, it is possible to solve, using a wireless network, a distance restriction in that a mobile terminal is connected to a USB port in a wired manner.

According to exemplary embodiments of the present invention, the user convenience that a user needs to install a USB device driver every time may be solved by downloading the USB device driver from a USB device driver server in a plug-and-play format and automatically installing the USB device driver.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram to describe a universal serial bus (USB) device service system according to an exemplary embodiment of the present invention.

FIG. 2 is a diagram to describe an operation process of a USB device service system according to an exemplary embodiment of the present invention.

FIG. 3 is a flowchart to schematically describe a USB device service method according to an exemplary embodiment of the present invention.

FIG. 4 is a diagram to describe a USB device service method further in detail according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

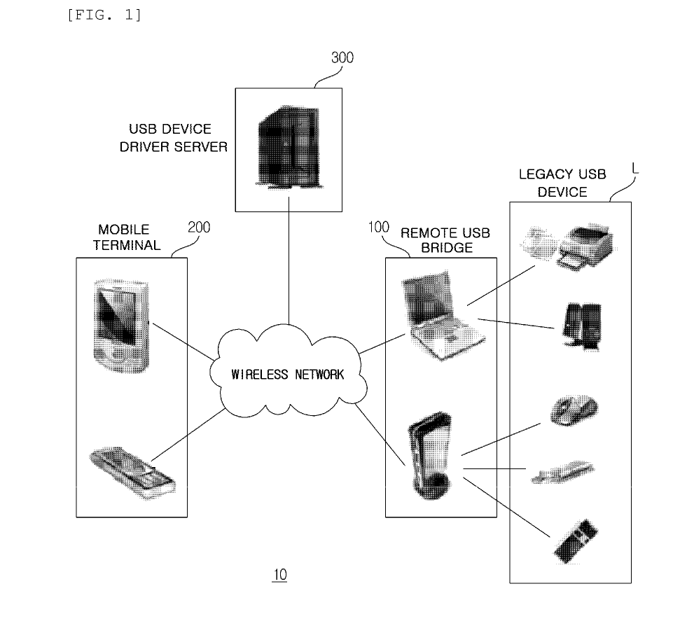

FIG. 1 is a diagram to describe a universal serial bus (USB) device service system 10 according to an exemplary embodiment of the present invention.

As shown in FIG. 1, the USB device service system 10 according to the exemplary embodiment includes a remote USB bridge 100, a terminal 200, and a USB device driver server 300.

The remote USB bridge 100 is a device connected by at least one legacy USB device L, and has one or a plurality of USB ports (receptacles) and is embedded with a USB host controller and thus controls the legacy USB device L attached to the USB port (receptacle). The remote USB bridge 100 will be further described in detail below.

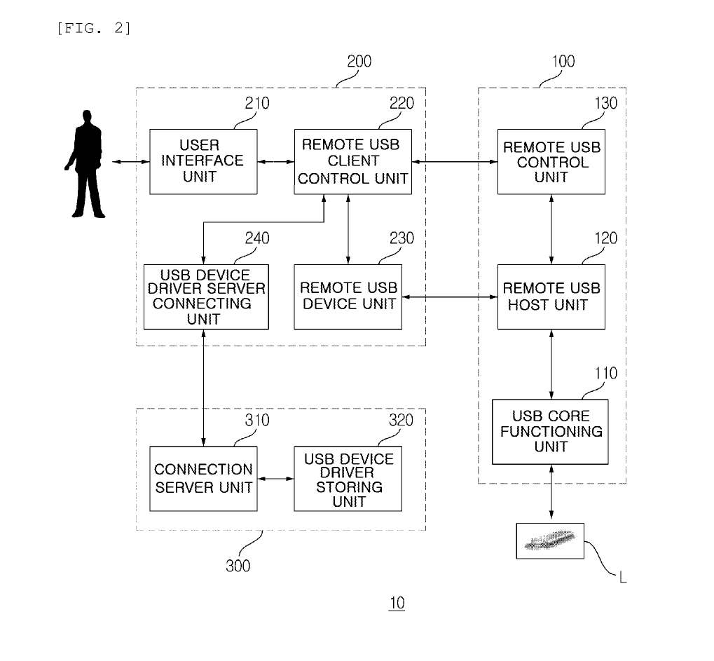

The terminal 200 indicates a general mobile terminal and is connected to the aforementioned remote USB bridge 200 over a wireless network to provide information about the legacy USB device L to a user and to receive a user input for use of the legacy USB device L. The terminal 200 will be further described in detail with reference to FIG. 2.

The USB device driver server 300 is connected to the aforementioned remote USB bridge 100 and the terminal 200 over the wireless network to provide a driving driver for driving the legacy USB device L according to the user input. The USB device driver server 300 will be further described in detail below.

FIG. 2 is a diagram to describe an operation process of a USB device service system according to an exemplary embodiment of the present invention.

As shown in FIG. 2, the remote USB bridge 100 includes a USB core functioning unit 110, a remote USB host unit 120, and a remote USB control unit 130. The terminal 200 includes a user interface unit 210, a remote USB client control unit 220, a remote USB device unit 230, and a USB device driver server connecting unit 240. The USB device driver server 300 includes a connection server unit 310 and a USB device driver storing unit 320.

The USB core functioning unit 110 of the remote USB bridge 100 recognizes the legacy USB device L as a plug-and-play format, which is performed using a function of the remote USB control unit 130 to be described below.

The remote USB host unit 120 controls the legacy USB device L via the USB core functioning unit 110 and connects the terminal 200 and the legacy USB device L over the wireless network. That is, the remote USB host unit 120 may be a kind of virtual proxy that performs a host function with respect to the legacy USB device L instead of a general USB host. Accordingly, in the legacy USB device L attached to the USB core functioning unit 110 that is a USB port (receptacle) of the remote USB bridge 100, the remote USB host unit 120 of the remote USB bridge 100 is connected to the remote USB device unit 230 of the terminal 200 to be described below and thereby is displayed on the terminal 200. That is, the remote USB device unit 230 is recognized as if the remote USB device unit 230 is a USB device attached to a local USB port (receptacle) in the mobile terminal 200, and provides a function of USB in interaction with other modules.

Next, the user interface unit 210 of the terminal 200 functions to receive an input from a user and display an operation result of the legacy USB device L to the user. The user may enquire and view peripheral remote USB bridges 100 and legacy USB devices L connected thereto using the user interface unit 210. Also, the user may select the legacy USB device L to be used by the user, and may transfer a command for connecting the selected legacy USB device L to the mobile terminal 200 via the user interface unit 210.

The remote USB client control unit 220 communicates with the remote USB bridge 100 to collect information about the legacy USB device L attached to the remote USB bridge 100. Next, the remote USB client control unit 220 transfers the collected information to the user interface unit 210, so that the user may select a device to be used. When the legacy USB device L selected by the user exists, the remote USB client control unit 220 requests the remote USB bridge 100 to use the selected legacy USB device L and controls the remote USB device unit 230 to connect the terminal 200 and the legacy USB device L.

The USB device driver server connecting unit 240 controls the driving driver for driving the legacy USB device L connected to the terminal 200 to be downloaded from the USB device driver server 300. Also, when downloading of the driving driver is completed, the USB device driver server connecting portion 240 enables the remote USB client control unit 220 to install the downloaded driving driver in the mobile terminal 200, and indicates, for the user via the user interface unit 210, that the legacy USB device L is available.

Next, the connection server unit 310 of the USB device driver server 300 receives, from the USB device driver server connecting unit 240 of the terminal 200, information about the terminal 200 such as a hardware type of the terminal 200, an operating system (OS) type and a version thereof, and the like, and legacy USB device L information such as a product identifier (ID), a vendor ID, a device class, a device descriptor, and the like about the legacy USB device L that is attached to the remote USB bridge 100 and that the user desires to use as a USB device of the mobile terminal 200 via the user interface unit 210, and transfers the received information to the USB device driver storing unit 320 to be described below.

The USB device driver storing unit 320 provides the driving driver for driving the legacy USB device L to the terminal 200 based on information received by the connection server unit 310. The connection server unit 310 provided with the driving driver downloads the driving driver to the USB device driver server connecting unit 240 of the mobile terminal 200 to thereby install the driving driver in the terminal 200.

Hereinafter, a USB device service method according to an exemplary embodiment of the present invention will be described.

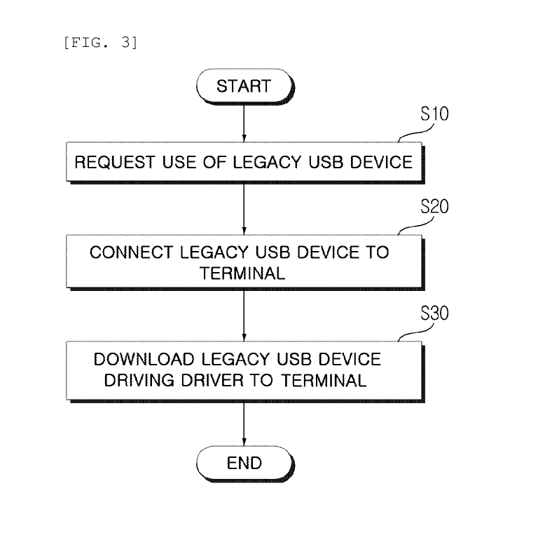

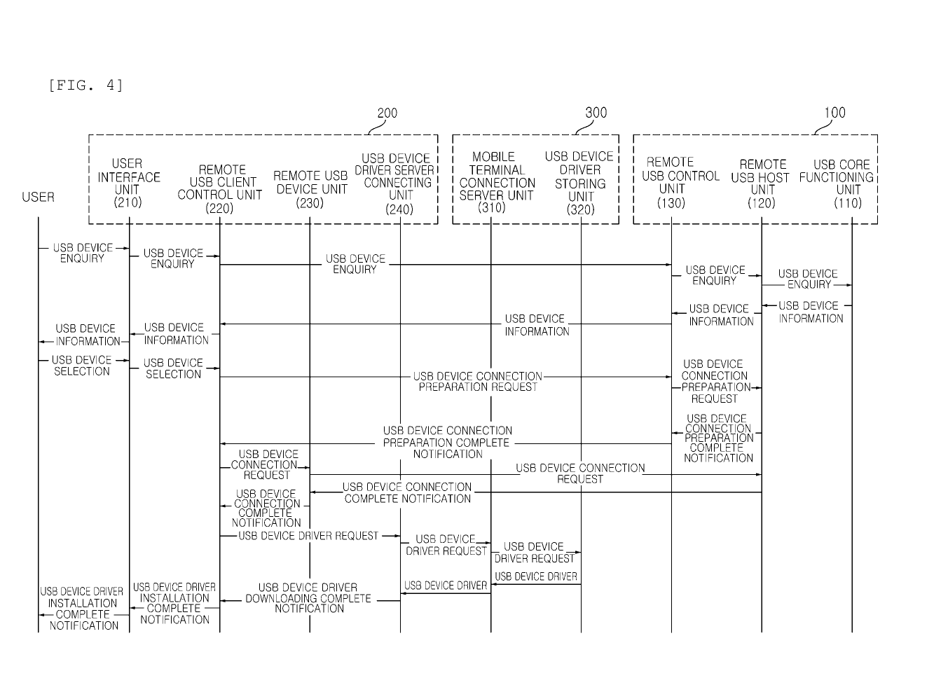

FIG. 3 is a flowchart to schematically describe a USB device service method according to an exemplary embodiment of the present invention, and FIG. 4 is a diagram to describe a USB device service method further in detail according to an exemplary embodiment of the present invention.

As shown in FIG. 3, the USB device service method includes requesting use of a legacy USB device (S10), connecting the legacy USB device to a terminal (S20), and downloading a driving driver for driving the legacy USB device to the terminal (S30).

Each of the operations is performed over a wireless network and a user of the terminal transmits a use request to a remote USB bridge in order to use a legacy USB device connected to the remote USB bridge, and the remote USB bridge receiving the use request connects the corresponding legacy USB device to the terminal over the wireless network. Also, the aforementioned USB device driver server existing in the wireless network is configured to download, to the terminal, the driving driver capable of driving the legacy USB device desired to be used in the terminal and thereby drive the legacy USB device in the terminal.

Hereinafter, an execution of the USB device service method according to the present invention associated with the aforementioned USB device service device will be further described in detail with reference to FIG. 2 and FIG. 4.

As shown in FIG. 4, the user inputs an enquiry command with respect to a legacy USB device (hereinafter, referred to as “USB device” for brief indication) via the user interface unit 210. The user interface unit 210 transmits the USB device enquiry command to the remote USB client control unit 220, and the remote USB client control unit 220 transmits the USB device enquiry command to the remote USB control unit 130. The remote USB control unit 130 enquires the USB device that is connected via the remote USB host unit 120 and the USB core functioning unit 110, and generates the enquired USB device as information and then transmits the USB device information to the remote USB client control unit 220. The remote USB client control unit 220 transmits the USB device information to the user interface unit 210 and the user interface unit 210 displays the USB device information for the user. When the user selects a USB device that the user desires to use, the user interface unit 210 transmits a device selection command to the remote USB client control unit 220, and the USB client control unit 220 transmits a corresponding USB device connection preparation request to the remote USB control unit 130. The remote USB control unit 130 transmits the received USB device connection preparation request to the remote USB host unit 120. In response thereto, the remote USB control unit 130 receives a USB device connection preparation complete notification from the remote USB host unit 120 and transmits the USB device connection preparation complete notification to the remote USB client control unit 220. Next, the remote USB client control unit 220 requests the remote USB device unit 230 for connection to the USB device, and the remote USB device unit 230 transmits the USB device connection request to the remote USB host unit 120 to thereby reply the USB device connection complete notification. The remote USB device unit 230 transmits the USB device connection complete notification to the remote USB client control unit 220 and the USB client control unit 220 transmits a USB device driving driver request signal to the USB device driver server connecting unit 240. The USB device driver server connecting unit 240 transmits the USB device driving driver request signal to the connection server unit 310 and thereby downloads the USB device driving driver that the connection server unit 310 obtains from the USB device driver storing unit 320. The USB device driver server connecting unit 240 transmits, to the remote USB client control unit 220, a downloading complete notification indicating that the driving driver is downloaded, and the USB client control unit 220 receiving the downloading complete notification transmits the downloading complete notification to the user interface unit 210. The user interface unit 210 displays and thereby informs the user that downloading of the driving driver is completed.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A universal serial bus (USB) device service system, comprising:
a remote USB bridge being connected by at least one legacy USB device;
a terminal being connected to the remote USB bridge over a wireless network to provide information about the legacy USB device to a user, and to receive a user input for use of the legacy USB device; and
a USB device driver server being connected to the remote USB bridge and the terminal over the wireless network to provide a driving driver for driving the legacy USB device according to the user input.

2. The system of claim 1, wherein the terminal comprises:
a user interface unit to receive the user input and to output an operation result of the legacy USB device; and
a remote USB client control unit to collect information about the legacy USB device from the remote USB bridge, and to transfer the collected information to the user interface unit.

3. The system of claim 2, wherein the terminal further comprises:
a remote USB device unit controlling the legacy USB device, selected according to the user input inputted into the user interface unit, to be connected to the terminal; and
a USB device driver server connecting unit controlling a driving driver for driving the legacy USB device connected to the terminal to be downloaded from the USB device driver server.

4. The system of claim 2, wherein the user interface unit provides, to the user, enquiry information about the peripheral remote USB bridge and the legacy USB device connected to the remote USB bridge.

5. The system of claim 2, wherein the user interface unit transmits a command for connecting the legacy USB device selected by the user to the terminal to the remote USB bridge.

6. The system of claim 1, wherein the remote USB bridge comprises:
a USB core functioning unit to recognize the legacy USB device as a plug-and-play format;
a remote USB host unit to control the legacy USB device via the USB core functional unit, and to connect the legacy USB device and the terminal over the wireless network; and
a remote USB control unit to transmit information about the legacy USB device recognized by the USB core functioning unit to the terminal, and to control the remote USB host unit according to the user input inputted into the terminal.

7. The system of claim 1, wherein the USB device driver server comprises:
a connection server unit to receive information about the terminal and information about the legacy USB device; and
a USB device driver storing unit to provide the driving driver for driving the legacy USB device to the terminal based on information received by the connection server unit.

8. The system of claim 7, wherein information about the terminal comprises at least one of a type of hardware of the terminal, a type of an operating system of the terminal, and a version thereof.

9. A USB device service method, comprising:
transmitting a request for using a legacy USB device to a remote USB bridge connected by a remote legacy USB device via a terminal of a user;
connecting the legacy USB device to the terminal according to the request; and
downloading a driving driver for driving the legacy USB device in the terminal to the terminal by verifying information about the terminal and information about the legacy USB device.

10. The method of claim 9, wherein the transmitting comprises:
requesting information enquiry about the legacy USB device connected to the remote USB bridge via the terminal of the user;
transmitting information about the legacy USB device to the terminal according to the request; and
transmitting a request for using a legacy USB device desired to be used to the remote USB bridge based on the transmitted information.

11. The method of claim 9, wherein the transmitting, the connecting, and the downloading is performed over the wireless network.
